(19) United States
(12) Patent Application Publication
(10) Pub. No.: US 2026/0253502 A1
(43) Pub. Date: Aug. 27, 2026

(54) NAVIGATION FROM SENSORS IN GNSS-DENIED ENVIRONMENTS

(71) Applicant: Rockwell Collins, Inc., Cedar Rapids, IA (US)

(72) Inventors: Brian Helfrecht, Wilsonville, OR (US); Paolo Veneruso, Cedar Rapids, IA (US); Enrico Miccio, Cedar Rapids, IA (US); Carlo Tiana, Goldendale, WA (US)

(21) Appl. No.: 19/310,624

(22) Filed: Aug. 26, 2025

(30) Foreign Application Priority Data
Sep. 4, 2024 (EP) 24425039.5
Sep. 4, 2024 (EP) 24425040.3

(51) Int. Cl. G08G 5/54; G08G 5/21; G08G 5/32; G08G 5/38

(52) U.S. Cl. CPC G08G 5/54; G08G 5/21; G08G 5/32; G08G 5/38

(57) ABSTRACT

A system may include a ground mapping surveillance system configured to receive surveillance receive signals of an airfield environment. A system may include a data storage unit for storing one or more sets of reference airfield features associated with at least one airfield and comprising at least two reference feature elements. A system may include at least one surveillance processor configured to: detect, based on the surveillance receive signals, a feature set comprising a spatial arrangement of at least two feature elements; and map the feature set to at least one identified airfield feature of the one or more sets of reference airfield features. A system may include a navigation computing system configured to: determine an aircraft position relative to the at least two feature elements associated with the at least one identified airfield feature; and generate a flight path vector to the airfield feature.

### CROSS-REFERENCE TO RELATED APPLICATIONS

The present application claims the benefit under 35 U.S.C. § 119(e) of European Patent Office Patent Application Serial No. 24425039.5, filed September 4, 2024 and titled “REAL TIME AIRFIELD IDENTIFICATION AND GROUND ACCURATE INCURSION POSITIONING SYSTEM AND METHOD” and European Patent Office Patent Application Serial No. 24425040.3, filed September 4, 2024 and titled “NAVIGATION FROM SENSORS IN GNSS-DENIED ENVIRONMENTS”, both of which are incorporated by reference in their entirety.

### BACKGROUND

Global navigation satellite systems (GNSS) have provided navigation assistance for aircraft pilots for several decades. However, aircraft navigation that was previously easily enabled by GNSS is often no longer reliable. While there are ground-based systems that can assist in navigation/landings at airfields (e.g., Instrument Landing System (ILS)), aircraft have to be within their range to avail themselves of those systems. Therefore, there is a need for systems to provide navigation for aircraft in GNSS-denied environments.

### SUMMARY

In some aspects, the techniques described herein relate to an aircraft-based navigation system including: a ground mapping surveillance system configured to: receive surveillance receive signals of an airfield environment; a data storage unit for storing one or more sets of reference airfield features, wherein one or more reference airfield features of the one or more sets of reference airfield features are associated with at least one airfield and including at least two reference feature elements; at least one surveillance processor operatively coupled to the ground mapping surveillance system, the at least one surveillance processor configured to: detect, based on the surveillance receive signals, a feature set including a spatial arrangement of at least two feature elements; and map the feature set to at least one identified airfield feature of the one or more sets of reference airfield features; and a navigation computing system configured to: determine an aircraft position relative to the at least two feature elements associated with the at least one identified airfield feature; and generate a flight path vector to the airfield feature.

In some aspects, the techniques described herein relate to an aircraft-based navigation system, wherein the feature set includes a spatial arrangement of two or more beacons.

In some aspects, the techniques described herein relate to an aircraft-based navigation system, wherein the ground mapping surveillance system is further configured to transmit one or more surveillance transmit signals toward the airfield environment, wherein the one or more surveillance transmit signals are reflected and received as the surveillance receive signals.

In some aspects, the techniques described herein relate to an aircraft-based navigation system, wherein the flight path vector includes a 3D vector.

In some aspects, the techniques described herein relate to an aircraft-based navigation system, wherein the navigation computing system is further configured to generate a metric for the flight path vector.

In some aspects, the techniques described herein relate to an aircraft-based navigation system, further including at least one display unit operatively coupled to the at least one surveillance processor, the at least one display unit configured to present to a user at least one informative indicator associated with the flight path vector.

In some aspects, the techniques described herein relate to an aircraft-based navigation system, wherein the at least one display unit is configured to present to a user a visual representation of the flight path vector.

In some aspects, the techniques described herein relate to an aircraft-based navigation system, wherein the at least one informative indicator includes an estimated range to a touch-down point.

In some aspects, the techniques described herein relate to an aircraft-based navigation system, wherein the at least one informative indicator includes a global confidence metric, wherein the global confidence metric includes a statistical probability that the aircraft-based navigation system has identified a landing zone for landing an aircraft.

In some aspects, the techniques described herein relate to an aircraft-based navigation system, wherein the at least one informative indicator includes a local confidence metric, wherein the local confidence metric includes a statistical probability that the aircraft-based navigation system has identified the airfield feature associated with the at least two reference feature elements.

In some aspects, the techniques described herein relate to an aircraft-based navigation system, wherein the at least one display unit includes a head-up display.

In some aspects, the techniques described herein relate to an aircraft-based navigation system, further including at least one display unit operatively coupled to the at least one surveillance processor, the at least one display unit configured to present to a user at least one feature indicator corresponding to the at least one identified reference airfield feature.

In some aspects, the techniques described herein relate to an aircraft-based navigation system, wherein the at least one feature indicator includes at least one of a position or an orientation of the at least one identified airfield feature.

In some aspects, the techniques described herein relate to an aircraft-based navigation system, wherein the at least one feature indicator includes a confidence level associated with the at least one identified airfield feature.

In some aspects, the techniques described herein relate to an aircraft-based navigation system, wherein the ground mapping surveillance system includes at least one of a radar-based surveillance system or a lidar-based surveillance system.

In some aspects, the techniques described herein relate to an aircraft-based method for displaying flight data including: storing one or more sets of reference airfield features, wherein one or more reference airfield features of the one or more sets of reference airfield features are associated with at least one airfield and include two or more reference feature elements; receiving one or more surveillance receive signals of an airfield environment; detecting, based on the one or more surveillance receive signals, a feature set, wherein each feature set includes a spatial arrangement of one or more feature elements; mapping the feature set to at least one identified airfield feature of the one or more sets of reference airfield features; determining an aircraft position relative to the at least two feature elements associated with the at least one identified airfield feature; and generating a flight path vector to the at least one identified feature.

In some aspects, the techniques described herein relate to a method, further including, before receiving the one or more surveillance receive signals of the airfield environment, transmitting, via an aircraft-based ground mapping surveillance system, one or more surveillance signals toward the airfield environment.

In some aspects, the techniques described herein relate to a method, further including presenting to a user, via at least one aircraft-based display unit, the flight path vector.

In some aspects, the techniques described herein relate to a method, further including presenting to a user, via at least one aircraft-based display unit, a global confidence metric, wherein the global confidence metric includes a statistical probability that a landing zone for landing an aircraft has been identified.

In some aspects, the techniques described herein relate to a method, further including presenting to a user, via at least one aircraft-based display unit, a local confidence metric, wherein the local confidence metric includes a statistical probability that the aircraft-based navigation system has identified the airfield feature associated with the at least two reference feature elements.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims.

FIG. 1 is a block diagram illustrating a system for navigating from sensors in GNSS-denied environments.

FIG. 2 illustrates a diagram of an environment including aircraft utilizing a navigation system, in accordance with one or more embodiments of the disclosure.

FIG. 3 illustrates an exemplary environment of an airfield that includes an airfield feature, and a feature set of feature elements associated with the airfield feature, in accordance with one or more embodiments of the disclosure.

FIG. 4 illustrates a diagram of an aircraft attempting to land at a runway, in accordance with one or more embodiments of the disclosure.

FIG. 5 illustrates a display unit operating within an aircraft cockpit, in accordance with one or more embodiments of the disclosure.

FIG. 6 illustrates a process flow diagram depicting a method for generating and displaying flight data, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience, and “a” and “an” are intended to include “one” or “at least one,” and the singular also includes the plural unless it is obvious that it is meant otherwise.

Finally, as used herein, any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, embodiments of the concepts disclosed herein may be directed to a system and method for aircraft sensor-based navigation, such as navigation for detecting landing zones (e.g., airfields, runways, helipads) under low-visibility (e.g., cloudy weather, fog) and GNSS-compromised environments. The system and method use received signals, such as radar returns, from a unique set of spatially defined feature elements located near the landing zone and generate a flight path vector, such as a flight path vector to a desired location in the landing zone, based on the received signals and relative to the platform. The system and method also generate a confidence metric for the validity of the flight path vector. The system and method may also be used similarly to an instrument landing system (ILS), particularly if other landing assistance systems are not available.

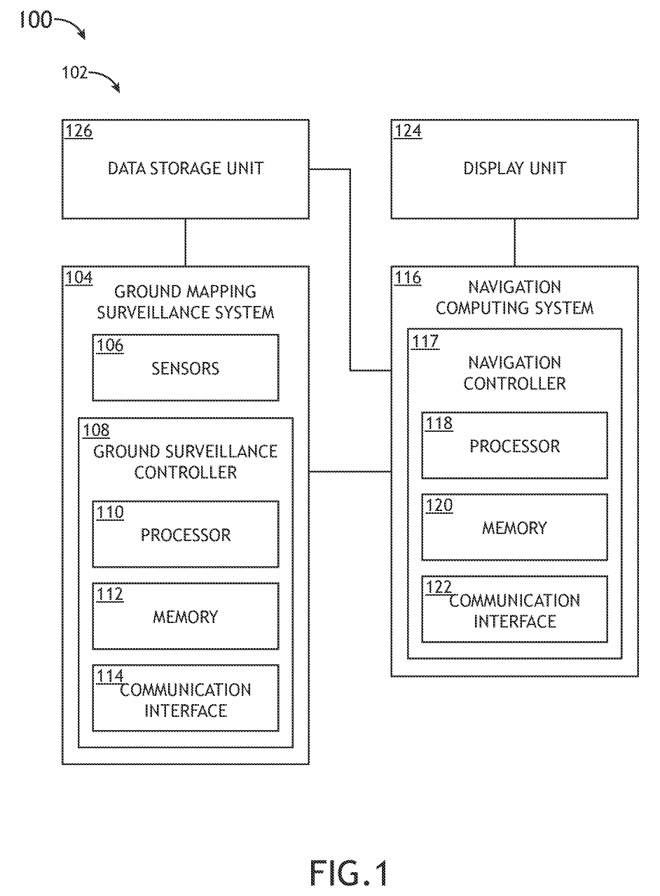

Referring now to FIG. 1, an exemplary system 100 for navigating from sensors (e.g., in GNSS-denied environments) is depicted, according to the inventive concepts disclosed herein. In embodiments, the system 100 may include an aircraft 102 (e.g., a piloted, remotely piloted, and/or uncrewed aerial vehicle (UAV)). The aircraft 102 may be a fixed-wing aircraft or a rotary-wing aircraft.

In embodiments, the system 100 includes a ground mapping surveillance system 104. The ground mapping surveillance system 104 may include one or more sensors 106 for sensing surveillance receive signals. The surveillance receive signals may include, but not be limited to, radar signals, lidar signals, infrared signals, optical image signals, and sonar signals. The sensors 106 may include sensors for any aircraft-surveillance technology, including, but not limited to, radar devices (e.g., primary radar, secondary surveillance radar, radar altimeters, weather radar, and ground mapping radar). For example, the sensors 106 may include long-range ground mapping sensors that utilize radar technology. The sensors 106 may also be configured to transmit one or more surveillance transmit signals that are reflected and received as the surveillance receive signals. The sensors 106 may include, but not be limited to, radar sensors, lidar sensors, and sonar sensors, such as sensors 106 for the transmission/reflective sensors for radar, lidar, and sonar. The ground mapping surveillance system 104 further includes a ground surveillance controller 108 configured to perform the functions of the ground mapping surveillance system 104 as described herein. The ground surveillance controller 108 may include one or more processors 110, memory 112, and a communication interface 114. The ground surveillance controller 108 may also be configured as a processor.

In embodiments, the system 100 includes a navigation computing system 116. The navigation computing system 116 is configured to receive data from the ground mapping surveillance system 104, determine a position and/or orientation of the aircraft relative to a detected landing zone, and generate a flight path vector to the landing zone. The navigation computing system 116 may also be configured to determine one or more metrics characterizing the probability that the generated flight path vector is correct. These metrics may include a local confidence metric and a global confidence metric, as described herein. The navigation computing system 116 includes a navigation controller 117 configured to perform the functions of the navigation computing system 116 as described herein. The navigation controller 117 may include one or more processors 118, memory 120, and a communication interface 122. The navigation computing system 116 may also be configured as a processor. The navigation computing system 116 and the ground mapping surveillance system 104 may be implemented as separate or combined systems within the aircraft 102. For example, the navigation computing system 116 and the ground mapping surveillance system 104 may be implemented together or separately within one or more Line Replaceable Units (LRUs). In embodiments, the ground mapping surveillance system 104 and the navigation computing system 116 share one or more controllers 108, 117, one or more processors 110, 118, one or more memory 112, 120, and/or one or more communication interfaces 114, 122.

In embodiments, the system 100 includes a display unit 124 communicatively coupled to the navigation computing system 116 and configured to display output from the navigation computing system 116, such as the flight path vector. The display unit 124 may include any type of display including, but not limited to, a primary flight display (PFD), multi-function display (MFD), head-up display (HUD), navigation display (ND), an Engine Indicating and Crew Alerting System (EICAS) display, an Electronic Centralized Aircraft Monitor (ECAM) display, an electronic flight bag (EFB), a flight management system (FMS) control display unit (CDU), and a synthetic vision system (SVS). The system 100 may include one or more of the display unit 124, the ground mapping surveillance system 104, the navigation computing system 116, and the aircraft 102.

In embodiments, the system 100 includes a data storage unit 126. The data storage unit 126 includes non-volatile memory for storing one or more sets of reference airfield features and associated reference feature elements (e.g., the stored reference airfield features and reference feature elements referring to real-world airfield features and real-world feature elements located at or near the airfield, respectively). Reference airfield features include objects mapped in reference databases stored in the data storage unit 126 that correspond to the airfield environment, including, but not limited to runways, taxiway, aprons, parking lots, or other subdivisions within the airfield environment. For example, reference airfield features may include specific airfield markers that are known from published resources. For instance, the reference airfield features may include markers/lights from Approach Lighting Systems (ALS) or features from military marking patterns. Reference airfield features may also include any detectable airfield features associated with the airfield including, but not limited to, approach lighting, edge lighting, runway/taxiway markers, signage, and runway/taxiway reflectors. In some embodiments, airfield features known to the reference databases stored in the data storage unit 126 may include other natural or manmade features such as trees, bodies of water, buildings, structures, and hangars.

In embodiments, the data storage units store reference feature elements associated with the reference airfield features. Reference feature elements may include a spatially defined set of objects (e.g., a feature set) having relatively large radar cross-sections that are associated with the feature element, including, but not limited to, taxiway intersection signage, embedded taxiway lights, beacons, and runway remaining markers that are unique for a specific airfield or runway. For example, the feature set may include a set of reference feature elements, such as the published reference feature elements described above, that provide a distinct spatial configuration (e.g., a constellation or fingerprint) identifiable by the system 100. The system 100 then provides a flight path vector based on the airfield feature associated with the fingerprint.

Reference airfield features may include permanent objects (e.g., signage, approach lights, trees, buildings) or temporarily placed objects (e.g., construction barricades). For example, temporarily placed objects may include objects specifically placed in a known pattern that demarks a landing zone. For instance, for a remote base in a desert having no established landing zone, a set of temporarily placed objects, such as high radar cross-section (RCS) targets (e.g., corner reflectors), may be placed at the base that allows aircraft employing the system 100 to identify the landing zone and land. After landing, the reference features may be subsequently removed. Reference features may also be static objects or mobile/dynamic objects. For example, a moving reference feature may include a bus, train, or trolley known to transport passengers between two concourses of an airport. Moving reference features may further include objects that move in a known, repeatable, and/or predicted manner, such as a bus traveling with a known schedule along a predictable path. The reference feature elements assist in identifying the airfield without relying on maps, GNSS data (e.g., GPS, GLONASS, Galileo, BeiDou, QZSS), or other indicators (e.g., a priori information) that would otherwise be used to identify the airfield.

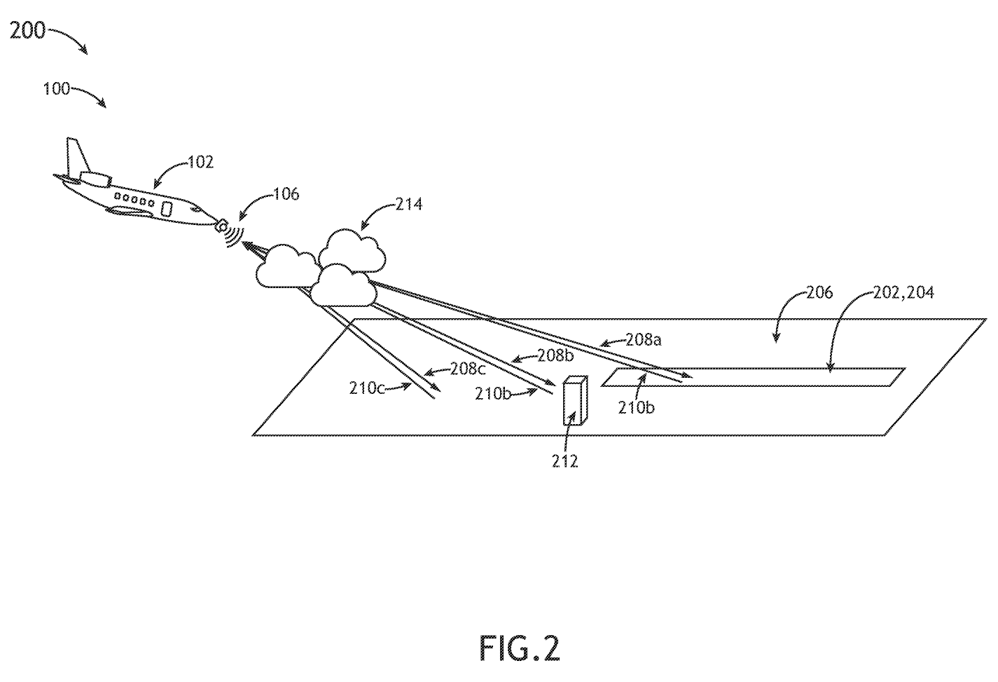

FIG. 2 illustrates a diagram of an environment 200 within which an aircraft 102 is utilizing the system 100 as described herein to direct itself to a reference airfield feature 202 (e.g., landing zone 204) within an airfield 206, in accordance with one or more embodiments of the disclosure. While the figure illustrates the aircraft 102 as a fixed-wing aircraft approaching the landing zone 204, the system 100 may also be utilized to assist other aircraft, such as a rotary-wing aircraft (e.g., helicopter, gyrocopter), to land (e.g., at a helipad). For example, the system 100 may be utilized for assisting aircraft associated with Advanced Air Mobility (AAM) platforms. For instance, the system 100 may be utilized for assisting AAM-associated aircraft in landing at vertiports. Therefore, the description herein should not be interpreted as a limitation on the embodiments of the present disclosure but merely as an illustration.

In embodiments, the ground mapping surveillance system 104 is configured to transmit one or more surveillance transmit signals 208a-c and/or receive one or more surveillance receive signals 210a-c. For example, the system 100 may utilize a radar sensor 106 to transmit surveillance transmit signals in the direction of an airfield 206 and receive reflected surveillance receive signals 210a-c. For instance, the sensor 106 may be a radar-based sensor 106 that can scan the ground under conditions where clouds 214 reduce optical visibility. In another example, the system may utilize image sensors (e.g., a camera) to receive the surveillance receive signals 210a-c.

In embodiments, the ground mapping surveillance system 104 is configured to detect and/or identify one or more feature elements 212 associated with the airfield feature 202, based on the received surveillance receive signals. The airfield feature 202 may be associated with any number (e.g., two or more) or type of feature element 212. For example, as shown in FIG. 2, the feature 202 (e.g., runway) is associated with the feature element 212 (e.g., a block). In another example, the airfield feature 202 may itself be considered a feature element 212. In another example, the runway of the landing zone 204, if detected, may itself be considered a feature element 212. In another example, the runway markings on the landing zone 204, if detected, may be considered a feature element 212. In another example, individual lights and signs surrounding the landing zone 204 may be considered feature elements 212. In another example, runway markings and/or edge lights may be considered feature elements 212 or as airfield features 202 containing feature elements 212. In another example, signs, trees, buildings, and other objects outside the landing zone 204 may be considered as feature elements 212 associated with the airfield feature 202 (e.g., the landing zone 204). Therefore, the feature elements 212 may include, be physically/spatially contained within, and/or be associated with, the airfield feature 202.

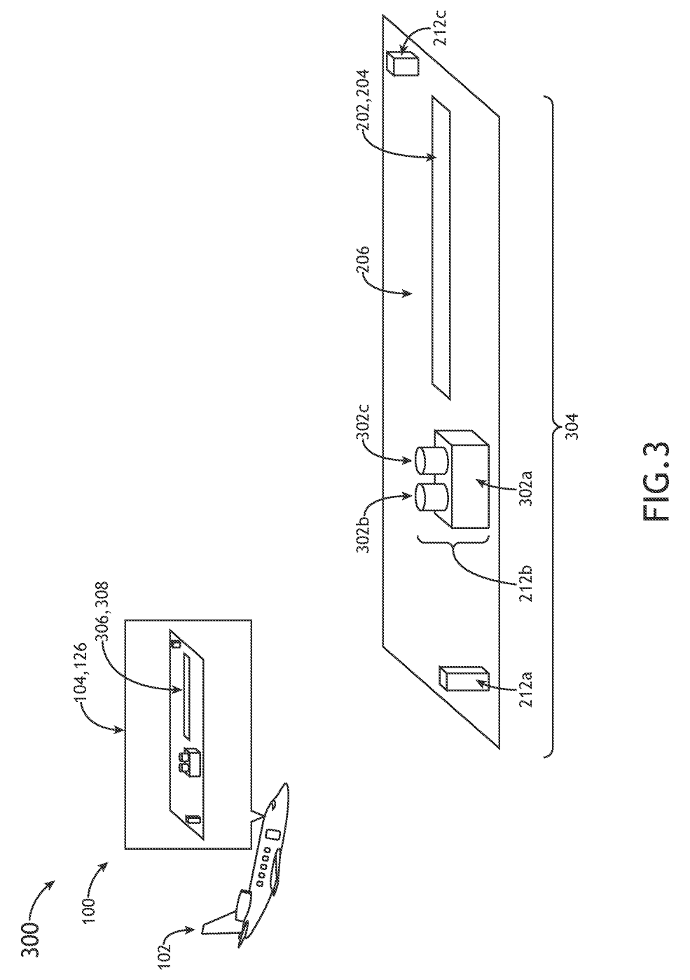

FIG. 3 illustrates an exemplary environment of an airfield 206 that includes the airfield feature 202 (e.g., a landing zone 204) and a feature set of feature elements 212 associated with the airfield feature, in accordance with one or more embodiments of the disclosure. For example, the airfield 206 shows the feature set 304 having feature elements 212a-c. In some embodiments, the feature elements 212b include multiple detectable subunits 302a-c.

The feature set 304 may include a spatial arrangement of feature elements 212 that may be unique to a specific airfield feature 202 (e.g., airfield 206 or landing zone 204), allowing an aircraft 102 deploying the ground mapping surveillance system 104 an ability to identify the airfield 206 and/or landing zone 204 without relying on GNSS or a priori data for the airfield environment. For example, the ground mapping surveillance system 104, in communication with the data storage unit 126, may access files detailing the one or more sets of reference airfield features 306 and reference airfield elements 308 associated with the landing zone 204 or airfield 206. The feature set 304 may include or be configured as a constellation of feature elements 212.

In embodiments, the ground mapping surveillance system 104, via the one or more surveillance processors, is configured to map the feature set 304 to at least one identified airfield feature 202. For example, once the ground mapping surveillance system 104 has scanned the airfield 206 and detected/identified the feature set 304 of the feature elements 212a-c, the one or more surveillance processors 110 may determine the spatial distances between the feature elements 212a-c. This data is then compared to the virtual feature sets stored in the data storage unit 126, which includes spatial distance data for the sets of reference airfield features 306 and their associated reference feature elements 308. If a match is found between the feature set 304 and a set of reference feature elements 308, the airfield feature 202 (e.g., the landing zone 204) can be identified.

In embodiments, the navigation computing system 116, via one or more navigation processors 118, is configured to determine an aircraft position and/or orientation relative to the feature elements 212 associated with the one identified airfield feature 202. For example, once the system 100 has identified the landing zone 204 based on the feature elements 212, the navigation computing system 116 can then estimate and/or determine distances and/or orientation angles between the aircraft and the feature elements 212 and/or the identified airfield feature 202 (e.g., landing zone 204). The navigation computing system 116 may detect multiple airfield features 202 and derive multiple distances and/or orientation angles for these multiple airfield features.

In embodiments, the navigation computing system 116 is configured to generate a flight path vector to the airfield feature 202. For example, the navigation computing system 116 may generate a 3D flight path vector for the aircraft 102 to follow as a guide for landing at a landing zone 204, which is displayed on one or more display units 124. The navigation computing system 116 may also generate and/or send to the display unit 124 a confidence metric for the flight path vector. For example, the confidence metric may provide information (e.g., a statistic) indicating the confidence or probability that the landing zone 204 is the specific landing zone that the aircraft 102 had intended to land upon (e.g., a local confidence metric). In another example, the confidence metric may provide information (e.g. a statistic) indicating the confidence or probability that the landing zone 204, while possibly not being identified as the specific and intended landing zone, is a landing zone that will allow the aircraft to safely land (e.g., a global confidence metric).

In embodiments, the feature set 304 may include a plurality of feature elements 212 for an airfield feature 202 (e.g., a helipad) that are dependent on detection by reflective technologies (e.g., radar, lidar, optical sensors) for detection. For example, the airfield feature 202 may be associated with a set of feature elements 212 (e.g., spatially defined reflectors) that are readily detectable by radar-based sensors 106 and provide a unique signature or fingerprint that can be easily discerned from a set of feature elements 212 associated with another airfield feature 202. The unique signature or fingerprint also allows the system 100 to specifically identify the airfield feature via the reference feature elements 308 stored in the data storage unit 126.

In embodiments, the feature set 304 may include a plurality of feature elements 212 for an airfield feature 202 (e.g., a helipad) that is not dependent on detection by reflective technologies. For example, the airfield feature 202 may be associated with a set of feature elements 212 (e.g., spatially defined emitters or beacons) that are readily detectable by image sensors, infrared sensors, or other electromagnetic-based sensors, which provide a unique signature or fingerprint that can be easily discerned from a set of feature elements 212 associated with another airfield feature 202.

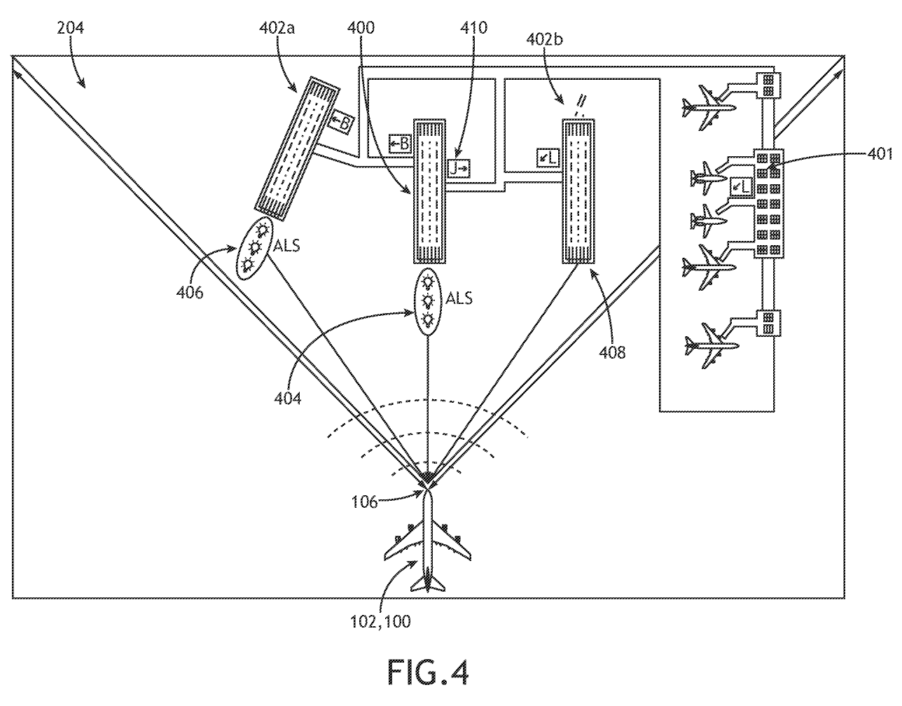

FIG. 4 illustrates a diagram of an aircraft 102 attempting to land at an airfield feature 202 (e.g., intended runway 400) of an airfield 206 that is adjacent to an airport terminal 401, in accordance with one or more embodiments of the disclosure. Adjacent to the intended runway 400 are two additional airfield features 202 (e.g., alternate runways 402a-b) that are capable of providing a landing zone 204 for the aircraft 102. Using the sensor 106 to scan the airfield 206, the system detects a feature set 304 of feature elements that includes a first set of approach lights 404 from an approach lighting system (ALS) at the approach of the intended runway 400, a second set of approach lights 406 at the approach of one alternate runway 402a, and no approach lights at the third alternate runway 402b. Based on the detected sets of approach lights, or absence of approach lights, a feature set 304 is generated via the system 100 that then is mapped to stored sets of reference airfield features 306 and their associated reference feature elements 308. Once a match between the feature set 304 and the reference feature elements 308 are found (e.g., the intended runway 400 becoming the identified airfield feature 202), the system 100 determines the relative position and orientation of the aircraft 102 to the intended runway 400 associated with the identified airfield features 306, and generates a flight path vector and/or confidence metric. Other objects near the intended runway 400 may also be used as feature elements 308, including runway markings 408, signage 410, the airport terminal 401, and the alternate runways 402a-b.

In embodiments, the system 100 is configured to determine confidence metrics (e.g., local confidence metrics or global confidence metrics) to one or more airfield features 202 within an airfield 206. For example, the system 100 may assign a local confidence metric (e.g., that the intended runway 400 is the correct runway) and/or a global confidence metric for the intended runway 400. In another example, the system 100 may both assign local confidence metrics and global confidence metrics, inferring that while the alternate runways 402a-b are likely not the intended runway 400, they potentially may be acceptable alternatives to the intended runway 400.

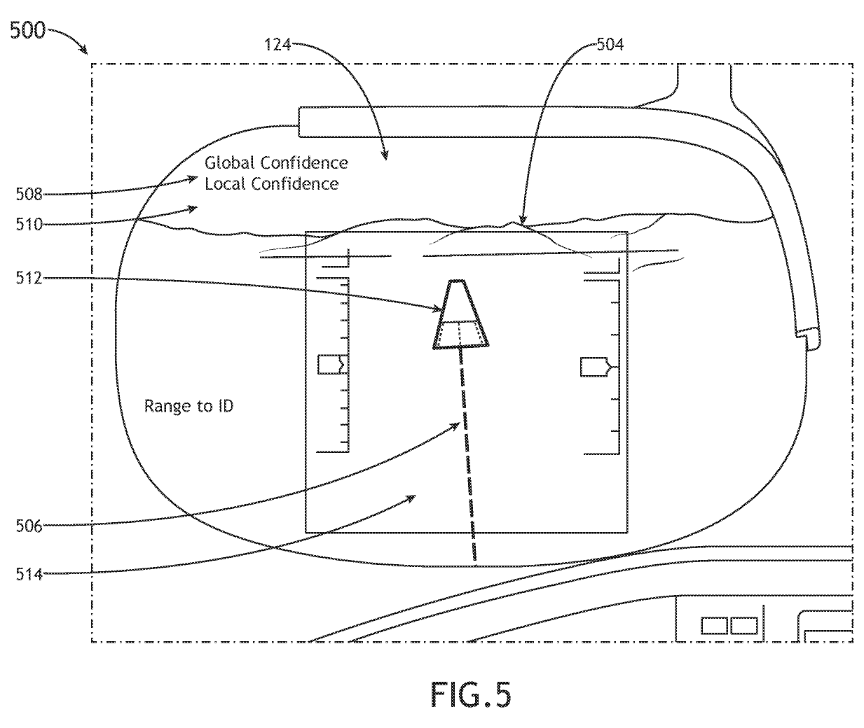

FIG. 5 illustrates a display unit 124 (e.g., a head-up display (HUD)) operating within an aircraft cockpit 500, in accordance with one or more embodiments of the disclosure. The display unit 124 is configured to display a symbology set 504 that assists the user in operating the aircraft 102. The display unit 124 is communicatively coupled to one or more processors 110, 118 of the system 100.

In embodiments, the display unit 124 is configured to present to a user at least one of a flight path vector 506 and/or an informative indicator associated with the flight path vector. For example, the display unit 124 may be configured to display one or more of the global confidence metric 508, the local confidence metric 510, predicted landing zone markers/indicators 512, and an estimated range to touch-down point 514.

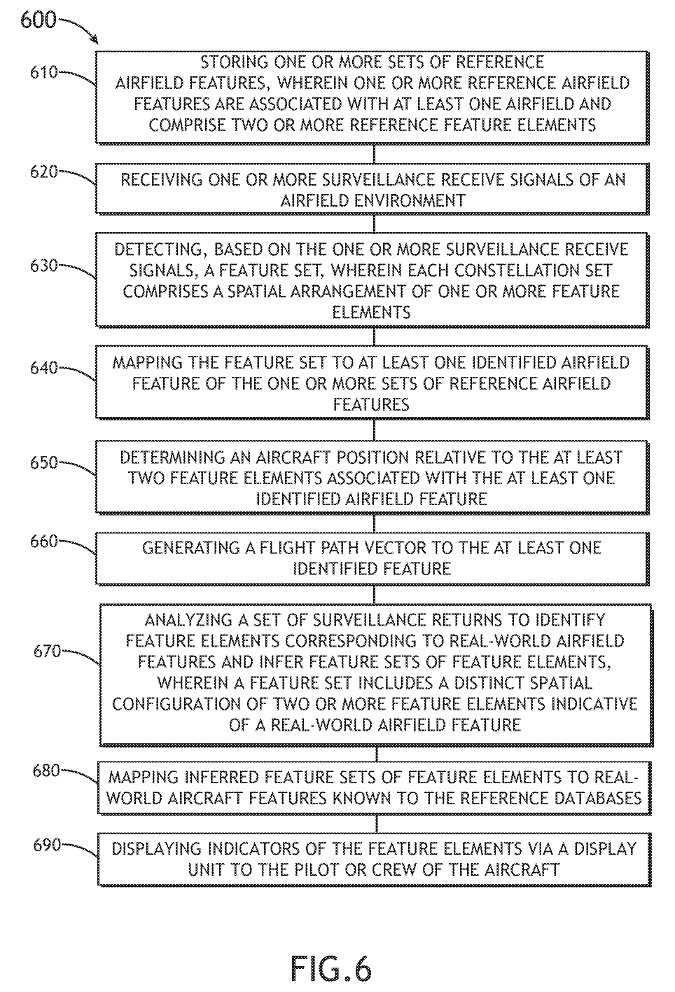

FIG. 6 illustrates a process flow diagram depicting a method 600 for generating and displaying flight data, in accordance with one or more embodiments of the disclosure. The method may be utilized by any of the systems 100 and system componentry as described herein. For example, the method 600 may be utilized to compute and/or display at least one of a flight path vector 506 (e.g., a visual representation of the flight path vector) and/or an informative indicator associated with the flight path vector onto a head-up display (HUD).

In embodiments, the method 600 includes a step 610 of storing one or more sets of reference airfield features 306, wherein one or more reference airfield features 306 are associated with at least one airfield 206 and include two or more reference feature elements. For example, reference databases of airfield environments and real-world airfield features thereof may be stored in a data storage unit 126 accessible to the system 100. In some embodiments, the data storage unit 126 includes either an onboard memory or cloud-based data storage accessible to the system 100 in real-time or near real-time. In some embodiments, airfield environments include airports, heliports, droneports, spaceports, and/or urban environments. In some embodiments, airfield features include runways, taxiways, aprons, and/or parking lots. For example, each airfield feature corresponds to a configuration of feature elements in a particular spatial configuration, e.g., runway/taxiway markers, approach and runway lighting structures, navigational lighting structures, reflectors, path or slope indicators, and/or signage.

In embodiments, the method 600 includes a step 620 of receiving one or more surveillance receive signals of an airfield environment. For example, the system 100 may receive via one or more sensors 106, reflections of transmitted surveillance signals (e.g., via radar or lidar). In another example, the system 100 may receive via images (e.g., visual or infrared) from a camera.

In embodiments, the method 600 includes a step 630 of detecting, based on the one or more surveillance receive signals, a feature set, wherein each feature set comprises a spatial arrangement of one or more feature elements.

In embodiments, the method 600 includes a step 640 of mapping the feature set to at least one identified airfield feature of the one or more sets of reference airfield features.

In embodiments, the method 600 includes a step 650 of determining an aircraft position relative to the at least two feature elements associated with the at least one identified airfield feature.

In embodiments, the method 600 includes a step 660 of generating a flight path vector to the at least one identified feature. For example, the flight path may be generated via the navigation computing system 116 and displayed upon the display unit 124.

In embodiments, the method 600 includes a step 670 of analyzing a set of surveillance returns to identify feature elements 212 corresponding to real-world airfield features and infer feature sets of feature elements, wherein a feature set includes a distinct spatial configuration of two or more feature elements indicative of a real-world airfield feature (e.g., two feature elements aligned at a distance and/or angle from each other may suggest two approach lighting systems and a runway extending between them).

In embodiments, the method 600includes a step 680 of mapping inferred feature sets of feature elements to real-world aircraft features (e.g., configurations of real-world feature elements) known to the reference databases. For example, feature sets 304 may map to runways, taxiways, and aprons within a larger airfield environment, as well as to a distinct airport or airfield (e.g., based on a high-level arrangement of runways and taxiways). For example, a given feature set may be mapped to one or more real-world airfield features to at least a threshold confidence level. In some embodiments, anomalous feature elements may be detected and inferred as an obstacle or incursion with respect to a runway, taxiway, or other mapped real-world airfield feature.

In embodiments, the method 600 includes a step 690 of displaying indicators via a display unit to the pilot or crew of the aircraft. For example, indicators include displayed representations of any identified airfields, runways, taxiways, or other features as well as their associated confidence levels. If a feature set is mapped to more than one real-world airfield feature, indicators may include an ordered list ranked by confidence level. In some embodiments, identified real-world features are augmented by position and/or orientation information received from an aircraft-based positioning system or inferred by the feature’s position or orientation with respect to the aircraft. In some embodiments, indicators include alerts or warnings with respect to a detected obstacle or incursion.

For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), one or more digital signal processors (DSPs), or a state device). In this sense, the one or more processors 110, 118 may include any device configured to execute algorithms and/or instructions (e.g., program instructions stored in memory 112, 120, 126).

The memory 112, 120, 126 may include any storage medium known in the art suitable for storing the one or more sets of program instructions executable by the associated one or more processors 110, 118. For example, the memory 112, 120, 126 may include a non-transitory memory medium. For instance, the memory 112, 120, 126 may include, but is not limited to, a read-only memory (ROM), a random-access memory (RAM), a magnetic or optical memory device (e.g., disk), a magnetic tape, a solid-state drive, and the like. The memory 112, 120, 126 may be configured to provide information to the controller 108, 117, or other components of the system 100. In addition, the memory 112, 120, 126 may be configured to store user input. The memory 112, 120, 126 may be housed in a common controller housing with the one or more processors 110, 118. The memory 112, 120, 126 may, alternatively or in addition, be located remotely with respect to the spatial location of the processors 110, 118, or the controller 108, 117. For example, the one or more processors 110, 118 and/or the controller 108, 117 may access a remote memory 112, 120, 126 accessible through a network (e.g., wireless, and the like) via one or more communication interfaces 114, 122.

The one or more communication interfaces 114, 122 may be operatively configured to communicate with components of the controller 108, 117 or any other componentry within the system 100. For example, the one or more communication interfaces 114, 122 may be configured to retrieve data from the one or more processors 110, 118 or other devices, transmit data for storage in the memory 112, 120, 126, retrieve data from storage in the memory 112, 120, 126, and so forth. The one or more communication interfaces 114, 122 may also be communicatively coupled with the one or more processors 110, 118 to facilitate data transfer between components of the controller 108, 117, and other components of the system 100. It should be noted that while the one or more communication interfaces 114, 122 are described as a component of the controller 108, 117, one or more components of the one or more communication interfaces 114, 122 may be implemented as external components communicatively coupled to the controller 108, 117 via a wired and/or wireless connection

It is to be understood that embodiments of the methods disclosed herein may include one or more of the steps described herein. Further, such steps may be carried out in any desired order, and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried out in addition to, or as substitutes for, one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. An aircraft-based navigation system comprising:
a ground mapping surveillance system configured to receive surveillance receive signals of an airfield environment;
a data storage unit for storing one or more sets of reference airfield features, wherein one or more reference airfield features of the one or more sets of reference airfield features are associated with at least one airfield and comprising at least two reference feature elements;
at least one surveillance processor operatively coupled to the ground mapping surveillance system, the at least one surveillance processor configured to:
detect, based on the surveillance receive signals, a feature set comprising a spatial arrangement of at least two feature elements; and
map the feature set to at least one identified airfield feature of the one or more sets of reference airfield features; and
a navigation computing system configured to:
determine an aircraft position relative to the at least two feature elements associated with the at least one identified airfield feature; and
generate a flight path vector to the airfield feature.

2. The aircraft-based navigation system of claim 1, wherein the feature set comprises a spatial arrangement of two or more beacons.

3. The aircraft-based navigation system of claim 1, wherein the ground mapping surveillance system is further configured to transmit one or more surveillance transmit signals toward the airfield environment, wherein the one or more surveillance transmit signals are reflected and received as the surveillance receive signals.

4. The aircraft-based navigation system of claim 1, wherein the flight path vector comprises a 3D vector.

5. The aircraft-based navigation system of claim 1, wherein the navigation computing system is further configured to generate a metric for the flight path vector.

6. The aircraft-based navigation system of claim 1, further comprising at least one display unit operatively coupled to the at least one surveillance processor, the at least one display unit configured to present to a user at least one informative indicator associated with the flight path vector.

7. The aircraft-based navigation system of claim 6, wherein the at least one display unit is configured to present to a user a visual representation of the flight path vector.

8. The aircraft-based navigation system of claim 6, wherein the at least one informative indicator comprises an estimated range to a touch-down point.

9. The aircraft-based navigation system of claim 6, wherein the at least one informative indicator comprises a global confidence metric, wherein the global confidence metric comprises a statistical probability that the aircraft-based navigation system has identified a landing zone for landing an aircraft.

10. The aircraft-based navigation system of claim 6, wherein the at least one informative indicator comprises a local confidence metric, wherein the local confidence metric comprises a statistical probability that the aircraft-based navigation system has identified the airfield feature associated with the at least two reference feature elements.

11. The aircraft-based navigation system of claim 6, wherein the at least one display unit comprises a head-up display.

12. The aircraft-based navigation system of claim 1, further comprising at least one display unit operatively coupled to the at least one surveillance processor, the at least one display unit configured to present to a user at least one feature indicator corresponding to the at least one identified reference airfield feature.

13. The aircraft-based navigation system of claim 12, wherein the at least one feature indicator includes at least one of a position or an orientation of the at least one identified airfield feature.

14. The aircraft-based navigation system of claim 12, wherein the at least one feature indicator includes a confidence level associated with the at least one identified airfield feature.

15. The aircraft-based navigation system of claim 1, wherein the ground mapping surveillance system includes at least one of a radar-based surveillance system or a lidar-based surveillance system.

16. An aircraft-based method for displaying flight data comprising:
storing one or more sets of reference airfield features, wherein one or more reference airfield features of the one or more sets of reference airfield features are associated with at least one airfield and comprise two or more reference feature elements;
receiving one or more surveillance receive signals of an airfield environment;
detecting, based on the one or more surveillance receive signals, a feature set, wherein each feature set comprises a spatial arrangement of one or more feature elements;
mapping the feature set to at least one identified airfield feature of the one or more sets of reference airfield features;
determining an aircraft position relative to the at least two feature elements associated with the at least one identified airfield feature; and
generating a flight path vector to the at least one identified airfield feature.

17. The method of claim 16, further comprising before receiving the one or more surveillance receive signals of the airfield environment, transmitting, via an aircraft-based ground mapping surveillance system, one or more surveillance signals toward the airfield environment.

18. The method of claim 16, further comprising presenting to a user, via at least one aircraft-based display unit, the flight path vector.

19. The method of claim 16, further comprising presenting to a user, via at least one aircraft-based display unit, a global confidence metric, wherein the global confidence metric comprises a statistical probability that a landing zone for landing an aircraft has been identified.

20. The method of claim 16, further comprising presenting to a user, via at least one aircraft-based display unit, a local confidence metric, wherein the local confidence metric comprises a statistical probability that an aircraft-based navigation system has identified the airfield feature associated with the at least two reference feature elements.
